(19) United States
(12) Patent Application Publication
(10) Pub. No.: US 2012/0023884 A1
(43) Pub. Date: Feb. 2, 2012

(54) BIOMASS HANDLING AND PROCESSING

(75) Inventors: Warren W. Spikes, Hugoton, KS (US); Kirk A. Spikes, Olathe, KS (US); Scott G. Spikes, Hugoton, KS (US)

(73) Assignee: BIOLINK J.V., Hugoton, KS (US)

(21) Appl. No.: 13/191,900

(22) Filed: Jul. 27, 2011

Related U.S. Application Data
(60) Provisional application No. 61/368,393, filed on Jul. 28, 2010.
(60) Provisional application No. 61/429,841, filed on Jan. 5, 2011.

(51) Int. Cl. A01D 37/00; A01D 75/00; B30B 9/30; A01D 43/00

(52) U.S. Cl. 56/131; 56/192; 56/473.5; 100/8

(57) ABSTRACT

Biomass handling and processing systems and methods are provided. In one embodiment, a method includes cutting biomass, transferring the cut biomass to an auger, utilizing the auger to form a row of biomass, and baling the row of biomass. The biomass is optionally transferred from the auger to the baler utilizing one or more conveyors. Additionally, one or more cleaning steps may be performed to separate contaminants from the biomass. In another embodiment, a biomass processing system includes a sickle, a pick-ups unit, and an auger. Biomass is cut by the sickle and transferred to the auger utilizing the pick-ups unit. The auger forms the biomass into a row. The row of biomass may then be transferred to a baler utilizing a conveyor. Systems also optionally include a rotor located between the pick-ups unit and the auger, and one or more grates that reduce contamination included with the biomass.

### REFERENCE TO RELATED CASES

The present application is based on and claims the priority of provisional applications Ser. No. 61/368,393 filed on Jul. 28, 2010, and Serial No. 61/429,841 filed on Jan. 5, 2011, the contents of which are hereby incorporated by reference in their entirety.

### BACKGROUND

Biomass is a renewable energy source that comes from biological material. Some examples of biomass include, but are not limited to, corn, switchgrass, and sorghum. Biomass is commonly harvested utilizing a three-pass operation. In the first pass, the biomass (e.g. cornstalks) is cut in a swathing or chopping pass. In the second pass, the biomass is raked into a windrow, and in the third pass, the biomass is baled such that it can be more easily handled, transported, and stored. Once the biomass has been harvested, it can then be used as a renewable energy source. For example, biomass can be used to generate ethanol for use as a fuel, or biomass can be used to generate electricity through incineration. It should be noted however that biomass is not limited to any particular type of material or use, and that biomass can include any biological material that is used for any purpose.

### SUMMARY

An aspect of the disclosure relates to handling and processing biomass. In one embodiment, a method includes cutting biomass, transferring the cut biomass to an auger, utilizing the auger to form a row of biomass, and baling the row of biomass. The biomass is optionally transferred from the auger to the baler utilizing one or more conveyors. Additionally, one or more cleaning steps may be performed to separate contaminants from the biomass.

In another embodiment, a biomass processing system includes a sickle, a pick-ups unit, and an auger. Biomass is cut by the sickle and transferred to the auger utilizing the pick-ups unit. The auger forms the biomass into a row. The row of biomass may then be transferred to a baler utilizing a conveyor. Systems also optionally include a rotor located between the pick-ups unit and the auger, and one or more grates that reduce contamination included with the biomass. The biomass is illustratively elevated from the ground such that the biomass does not contact the ground between the pick-ups unit and the baler. Furthermore, embodiments may include platforms that include caster wheels, floating wheels, hitches, and depth control sensors.

These and various other features and advantages that characterize the claimed embodiments will become apparent upon reading the following detailed description and upon reviewing the associated drawings.

### BRIEF DESCRIPTION OF THE DRAWINGS

FIG. 1 is a schematic diagram of a biomass processing system.

FIG. 2 is a flow diagram illustrating a method of processing biomass.

FIG. 3 is a side view of a biomass processing system having a conveyor.

FIG. 4 is a top down view of a biomass processing system platform.

FIG. 5 is a side view of a biomass processing system platform having an adjustable sickle.

FIG. 6 is a side view of a biomass processing system platform having a spring loaded shield.

FIG. 7 is a top down view of a biomass processing system with a baler.

FIG. 8 is a top down view of a biomass processing system with caster wheels.

FIG. 9 is a side view of a biomass processing system platform with caster wheels.

FIG. 10 is a side view of a biomass processing platform with a floating wheel.

### DETAILED DESCRIPTION

Embodiments of the present disclosure include methods and equipment for handling and processing biomass. In one embodiment, biomass is harvested in a one-pass operation. The one-pass operation illustratively includes cutting the biomass with sickles, moving the cut biomass into a row using an auger, and baling the biomass. The one-pass operation may also include transferring the biomass from the auger to the baler utilizing a conveyor, and removing contaminants from the biomass using various methods such as, but not limited to, grates, rotors, and/or cleaning modules. Accordingly, at least some embodiments of the present disclosure may be advantageous in that they increase efficiency by reducing the number of passes in harvesting biomass and may also improve the quality of biomass by reducing the amount of contaminants (e.g. dirt) in the biomass. For example, by using a conveyor between an auger and a baler, the amount of contact the biomass has with the ground is reduced, and the biomass is less likely to pick-up additional contaminants. These and other features and advantages are described in greater detail below and shown in the accompanying figures.

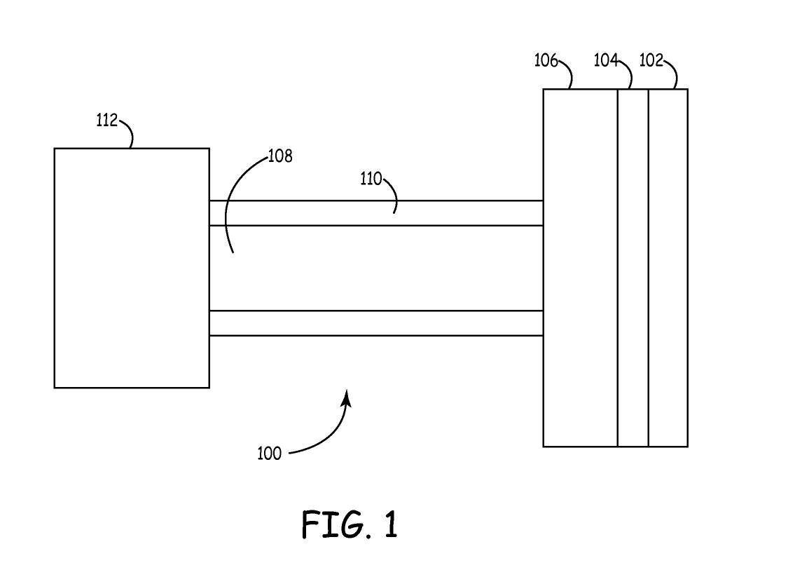

FIG. 1 is a simplified schematic diagram of a system 100 for processing biomass. In one embodiment, system 100 is implemented utilizing a tractor or combine, and is used in cutting biomass (e.g. corn stalks) and processing the cut biomass into bales. System 100 illustratively includes a cutting module 102, a pick-ups module 104, an auger module 106, a conveyor module 108, one or more cleaning units 110, and a baler 112. Cutting module 102 includes a cutting mechanism that cuts biomass such that it can be collected. Cutting module 102 may include sickles or any other suitable cutting mechanism. Once the biomass has been cut, pick-ups module 104 transfers the biomass to an auger module 106. Pick-ups module 104 may include a series of rotatable tynes, impellers, paddle type devices, or any other suitable transfer mechanism. Once the biomass is in auger module 106, an auger or other transfer mechanism moves the biomass to the conveyor module 108.

In an embodiment, conveyor module 108 transfers the biomass from the auger module 106 to the baler module 112 such that the biomass never touches the ground. In one particular embodiment, conveyor module 108 includes one or more belt conveyors. Embodiments are not however limited to any particular type of transfer mechanism. In at least some situations, the limited contact with the ground may be advantageous in that less contaminants (e.g. soil, etc.) are collected along with the biomass. For instance, some energy conversion processes may require or prefer less contaminants in their biomass. Certain embodiments of the present disclosure may help to collect biomass in such a manner to provide the biomass with the preferred reduced amounts of contaminants.

System 100 optionally includes one or more cleaning modules 110 along the conveyor module 108. Cleaning modules 110 are used to further remove contaminants from the biomass as it is moved across the conveyor module 108. In one embodiment, cleaning modules 110 project a fluid (e.g. air, nitrogen, water, cleaning solution, etc.) at the biomass to remove contaminants. Cleaning modules 110 are not however limited to any particular devices or methods of removing/reducing contaminants from biomass, and embodiments of cleaning modules 110 illustratively include any devices and/or methods for removing/reducing contaminants from biomass.

From conveyor 108, the biomass is then moved to baler module 112. Baler module 112 processes the biomass to form bales. Embodiments of the present disclosure are not limited to any particular type of baler and may include any baler (e.g. a self-propelled baler or a baler that is pulled). Additionally, some embodiments may not include a baler and may instead collect the biomass in a different manner. For instance, biomass may be moved from conveyor 108 to a storage/collection module.

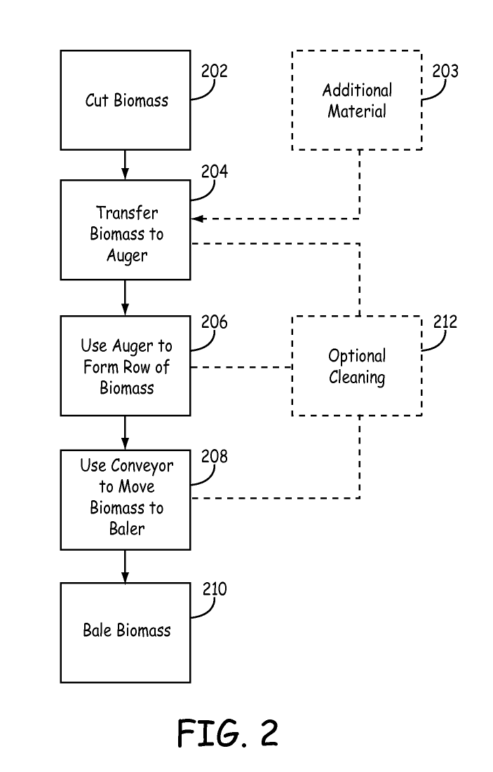

FIG. 2 is a simplified process flow diagram illustrating a method 200 for processing biomass. At block 202, the biomass is cut, for example, by using a sickle. At block 204, the cut biomass is transferred to an auger. The biomass may be transferred to the auger using pick-ups or any other suitable equipment. At block 206, the auger moves the biomass into a row. At block 208, the biomass is moved from the auger to the baler using a conveyor, and at block 210, the baler bales the biomass. Additionally, method 200 optionally includes one or more cleaning steps 212 to remove contaminants from the biomass. For instance, cleaning steps 212 may include utilizing grates, a rotor system, or a cleaning module (e.g. compressed air) to remove contaminants from the biomass.

Method 200 further optionally includes block 203 of receiving additional material 203. The additional material 203 is illustratively any material other than biomass cut by the sickles that is transferred to the auger utilizing the pick-ups. For example, after a combine has harvested a crop (e.g. corn or grains), the field may have leaves, husks, shredded stalks, other plants, and may even have some of the harvested crop remaining in the field (e.g. loose unharvested ears or grains). Additionally, some crops, stalks, etc. may be on the ground due to being knocked down by weather conditions such as hail, wind, rain, etc. In an embodiment, the additional material 203 or at least a portion of the additional material 203 is collected along with the cut biomass and is eventually baled at block 210 along with the cut biomass. This may be advantageous in several respects. For instance, the additional material 203 that is collected may be useful as an additional source of renewable energy (e.g. the additional material 203 can be used to produce ethanol or electricity through incineration). The collection of the additional material 203 may also be useful in that it provides a cleaner field for establishing seed beds while leaving the cover necessary to control erosion. Accordingly, at least certain embodiments of the present disclosure collect additional material other than just the cut biomass.

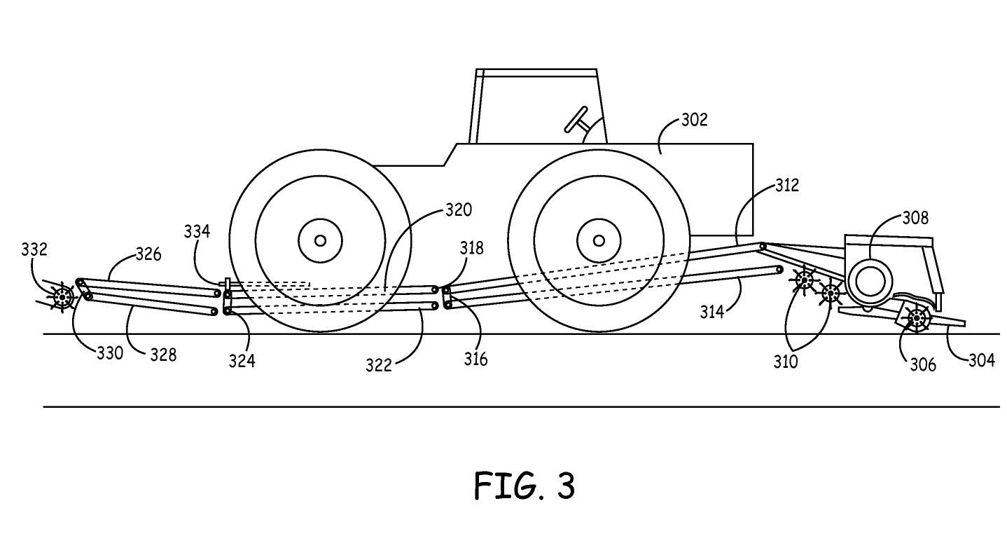

FIG. 3 is a side view of one example of a biomass processing system. It should be noted that embodiments of the present disclosure are not limited to the particular example shown in FIG. 3 and can include configurations different than that shown in the figure. In FIG. 3, the biomass processing system is implemented utilizing a four wheel drive articulated steering tractor 302. In certain embodiments, four wheel drive articulated steering tractors may be useful in that they provide sufficient space underneath the tractor to include the conveyor. Additionally, embodiments may be implemented on a tractor, combine, etc. that has larger diameter tires (e.g. rice tires) to provide for sufficient space for the conveyor. Embodiments are not however limited to any particular type of implementation system (e.g. tractor, combine, etc.) and are illustratively implemented using any type of system.

In the embodiment shown in FIG. 3, a sickle 304 cuts biomass. The cut biomass is then transferred to an auger module 308 utilizing pick-ups 306. Auger module 308 moves the cut biomass from the outer ends of the module towards the center of the module. From the center of the auger module 308, the biomass is moved towards the conveyor 312/314 utilizing one or more transfer mechanisms 310. Transfer mechanisms 310 may include pick-ups (e.g. tynes, impellers, paddles, etc.) or any other type of transfer mechanism. Additionally, as is shown in FIG. 3, the area in which the biomass is transferred from the auger to the conveyor may include one or more open areas or grates such that contaminants (e.g. soil) can be removed from the biomass by falling out of the biomass to the ground.

In the embodiment shown in FIG. 3, the conveyor includes multiple sections. Having multiple sections may be useful for allowing the conveyor to turn/bend with the system that it is attached to (e.g. an articulated tractor). Embodiments are not however limited to conveyors having multiple sections, and may also include conveyors having only one section.

In FIG. 3, the first conveyor section includes a top belt conveyor 312, a bottom belt conveyor 314, and a motor 316 (e.g. a hydraulic, electric, or pneumatic motor) that rotates bottom conveyor 314. In one embodiment, such as in the one shown in FIG. 3, the distance between top belt conveyor 312 and bottom belt conveyor 314 decreases going from the front of the conveyor to the back of the conveyor. This decreasing distance may help to compress the biomass and to move it along the conveyor.

In an embodiment having multiple conveyor sections such as that shown in FIG. 3, a pivot point assembly 318 is illustratively placed in between the conveyor sections to allow the conveyor sections to turn/bend as needed (e.g. to turn/bend as an articulated steering tractor turns). Pivot point assembly 318 connects the adjacent conveyor sections while enabling the sections to rotate relative to one another. Additionally, as is shown in FIG. 3, conveyors may include an open area or grate between conveyor sections that enables for additional contaminants (e.g. soil) to be removed from the biomass.

In the embodiment shown in FIG. 3, the biomass is moved from the first conveyor section to the second conveyor section. The second conveyor section illustratively includes a top belt conveyor 320, a bottom belt conveyor 322, and a motor 324 (e.g. a hydraulic, electric, or pneumatic motor) that rotates the bottom belt conveyor 322. In an embodiment, top belt conveyor 320 and bottom belt conveyor 322 are separated by an equal or approximately equal distance along the entire lengths of the conveyors. However, in another embodiment, the distance may vary along the length of the conveyors. For instance, the distance between the top conveyor 320 and bottom conveyor 322 may decrease going from the beginning of the conveyor to the end of the conveyor. This again may help compress the biomass and move the biomass along the conveyor.

From the second conveyor section, the biomass next moves to a force feed unit or final conveyor section. The final conveyor section is illustratively connected to a pivot point 334 (e.g. a tractor hitch pin) and is allowed to turn or rotate relative to the other conveyor sections. Additionally, as shown in FIG. 3, there may be an open area or grate between the final conveyor section and the second conveyor section that again allows for contaminants to fall out of the biomass. The final conveyor section illustratively includes a top belt conveyor 326, a bottom belt conveyor 328, and a motor 330 (e.g. a hydraulic, electric, or pneumatic motor) that rotates the bottom belt conveyor 328. The top belt conveyor 326 and bottom belt conveyor 328 may be separated by a same or approximately same distance along the entire length of the belts, or the distance between the conveyors may be reduced going from the beginning of the conveyor section to the end to compress the biomass. It is also worth noting that the belts of conveyors 326 and 328 may include ridges for moving the biomass or may alternatively be smooth belts. The other conveyor belts may similarly be either smooth or have ridges.

From the force feed unit/final conveyor section, the biomass is moved to a baler (not shown in FIG. 3). In one embodiment, a baler pick-ups 332 (e.g. rotatable tynes, impellers, or paddles) is used to move the biomass into the baler. Additionally, as shown in FIG. 3, there may be an open area or grate that allows for contaminants to fall out of the biomass before entering the baler.

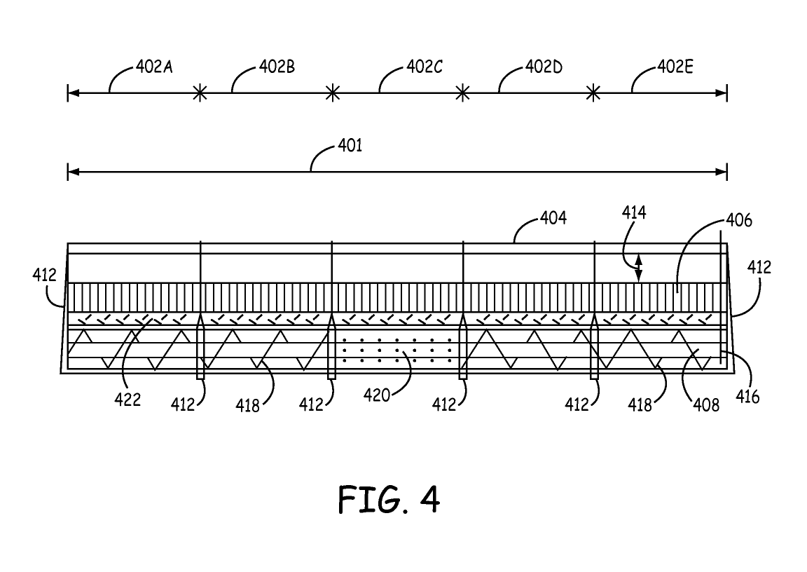

FIG. 4 is a top down view of a front unit or platform 400 of a biomass processing system. As can be seen in the figure, the sickle 404, pick-ups 406, and auger 408 run along approximately an entire length 401 of the platform 400. In one embodiment, the length 401 of the platform 400 is between 36 and 50 feet. Embodiments are not however limited to any particular length 401 and include any desirable length 401. FIG. 4 also shows that platform 400 includes a space or distance 414 between sickle 404 and pick-ups 406. In one embodiment, distance 414 is approximately nine to twelve inches. Distance 414 may however be adjusted as needed and include any desired dimensions. In FIG. 4, auger 408 illustratively includes a central rotatable axis 416, helical blades/protrusions 418, and non-helical blades/protrusions 420. Helical blades 418 are used to move the biomass from the outer ends of platform 400 towards the center of center of platform 400. Once the biomass is at the center, it is then moved backwards out of auger 408 by the non-helical blades 420.

In one embodiment, platform 400 may include one or more sickle supports 412 between each section 402A, 402B, 402C, 402D, and 402E of the platform 400. Accordingly, sickle supports 412 may be connected to and support sickle 404 at multiple points along the platform 400. For example, in the particular embodiment shown in the figure, platform 400 includes six sickle supports 412. Embodiments are not however limited to any particular number of sickle supports 412 and may include any number (e.g. 0, 1, 2, 3, 4, 5, etc.). In one particular embodiment, each section 402A, 402B, 402C, 402D, and 402E is approximately 5 feet, and the rigidity (e.g. stiffness) of sickle supports 412 may be increased by utilizing a laminated V-shape. Embodiments of sickle supports 412 are not however limited to any particular dimensions or to any particular methods of forming the supports.

Platform 400 may optionally includes a rotor 422 that is positioned between pick-ups 406 and auger 408, and that runs approximately along the entire length 401 of platform 400. Rotor 422 is illustratively rotatable about a central axis and has a number of protrusions (e.g. knives, paddles, impellers, tynes, etc.). Rotor 422 may be useful in removing some contaminants (e.g. dirt) from the biomass and/or cutting the biomass into smaller pieces. For instance, rotors 422 may agitate the biomass such that contamination is separated from the biomass and can be removed. Platform 400 could also have for example a grate or opening beneath rotors 410 that allows for the loose contaminants to drop through, and thus provide cleaner biomass to auger 408.

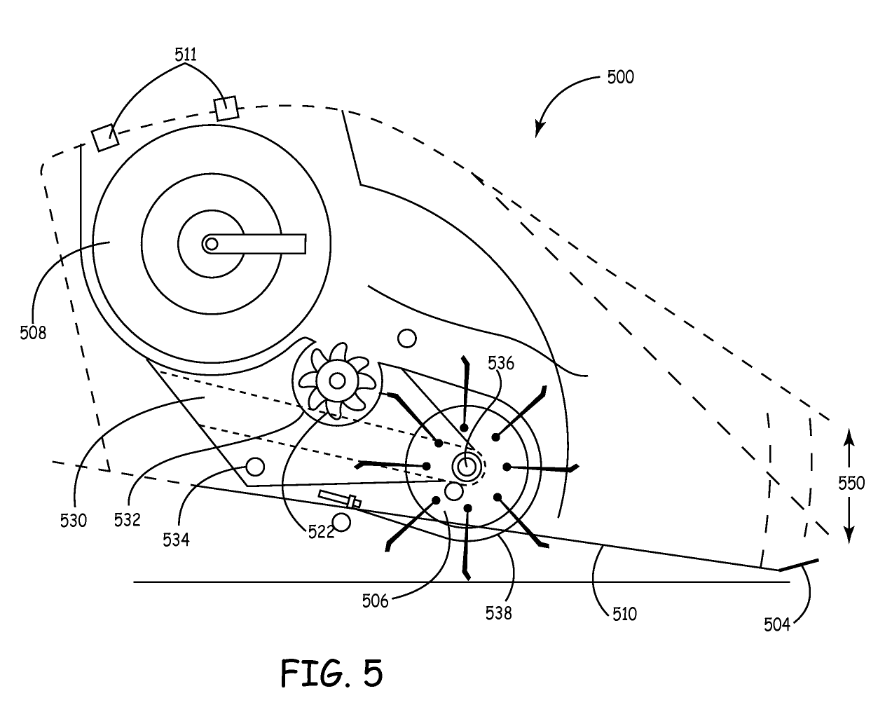

FIG. 5 is a side view of a platform 500. Similar to some of the embodiments shown in the previous figures, platform 500 also optionally includes a sickle 504, a pick-ups 506, a rotor 522, and an auger 508. Platform 500 may also include an inner support plate 530 and a rotatable end plate 510. Inner support plate 530 illustratively includes an aperture 532 that partially surrounds rotor 522. In one embodiment, inner support plate 530 also includes a pivot assembly 534 that rotatably connects inner support plate 530 to rotatable end plate 510. Pivot assembly 534 enables a height or position of sickles 504 to be adjusted relative to pick-ups 506, rotor 522, and auger 508. For example, pivot assembly 534 enables sickle 504 to be moved up and down in the direction shown by arrow 550. In an embodiment, rotatable end plate 510 is rigidly connected to sickle supports 412 (shown in FIG. 4) such that end plate 510 and sickle supports 412 move together to raise and lower the sickle 404. Additionally, rotatable end plate 510 may be connected to the platform 500 at one or more pivoting or rotatable connection points/joints 511. These features could be useful for example to control the height of the remaining biomass. For instance, regulations may require that a certain height of corn stalks (e.g. 6 inches) remain in a field to prevent soil loss. By including pivot assembly 534, sickles 504 can be adjusted to the appropriate height to cut the biomass, while maintaining pick-ups 506 at a height that effectively picks-up most of the biomass (e.g. if pick-ups 506 are too far off the ground, biomass may pass beneath the pick-ups and not be harvested).

FIG. 5 further shows that inner support plate 530 may include an aperture 536 that support an axle for rotating pick-ups 506, and that platform 500 may include one or more bands 538 that can be used to transfer rotational motion from a drive mechanism (e.g. hydraulic, pneumatic, electric, etc.) to the pick-ups 506. In one embodiment, pick-ups 506 are organized into separate sections, and one band 538 is positioned between each of the sections. Embodiments are not however limited to any particular implementation and may include configurations other than the specific example shown in FIG. 5. Additionally, it should be noted that the opposite end of platform 500 illustratively includes a same or similar configuration as that shown in FIG. 5 such that platform 500 includes a pair of inner support plates 530 and a pair of end plates 510 that are connected together to adjust the height of sickle 504 relative to pick-ups 506.

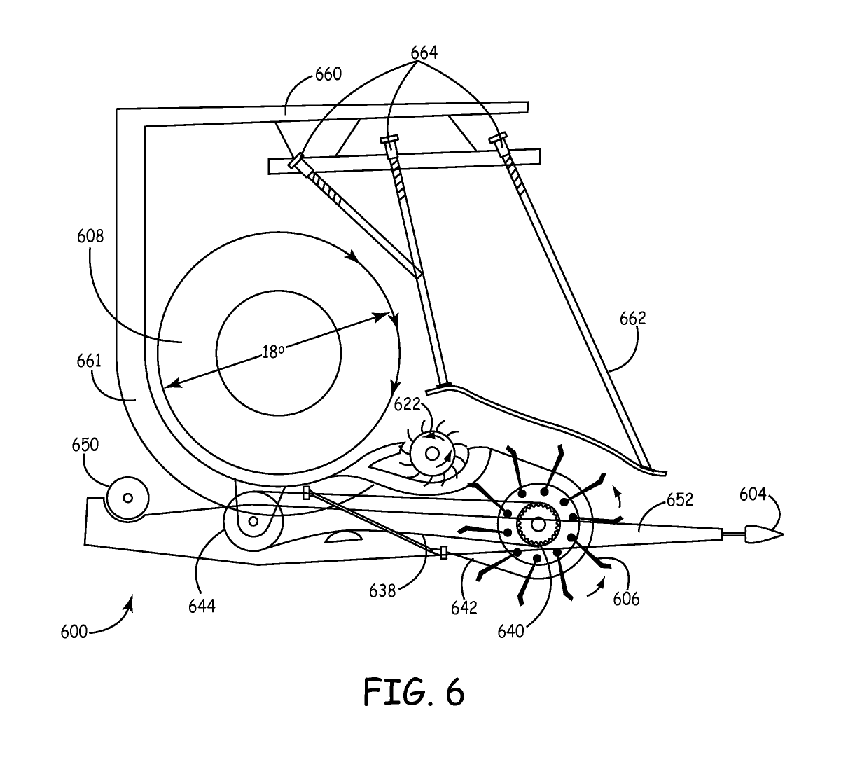

FIG. 6 is a side view of another embodiment of a platform, platform 600. Again, platform 600 may include a sickle 604, pick-ups 606, rotor 622, and auger 608. In one embodiment, pick-ups 606 are attached to a sprocket or gear 640, and rotation from a drive mechanism 644 is transferred to sprocket 640 through a chain 642. In another embodiment, other components such as belts, pulleys, etc. may be used instead of sprockets and chains. Embodiments are not however limited to any mechanisms for rotating pick-ups 606 or any of the other components (e.g. rotor 622 or auger 608) and include any components that can be used to supply rotation.

Sickle 604 is optionally connected to and supported by one or more support arms 652, and the one or more support arms 652 are rotatably connected to an eccentric or pivot axis 650. Similar to the configuration shown in FIG. 5, the configuration of eccentric 650, support arms 652, and sickle 604 in FIG. 6 enables a height of sickle 604 to be adjustable. For example, in one embodiment, the configuration shown in FIG. 6 enables height of sickle 604 to be adjustable between a minimum height of 3 inches from the ground to a maximum height of 12 inches from the ground.

Platform 600 illustratively includes a support brace 660 that runs along approximately an entire length (e.g. length 401 in FIG. 4) of platform 600. Brace 660 includes a U-shaped portion 661 that surrounds auger 608 and provides a pathway for biomass to be transferred to the center of the auger 608. Brace 660 also supports an optional shield assembly 662 that can be spring loaded utilizing one or more springs 664. Shield assembly 662 may be used to prevent unwanted matter/objects from entering platform 600. For instance, shield assembly 662 may prevent any object that is larger than the space between the sickle 604 and the shield 662 from entering the platform 600.

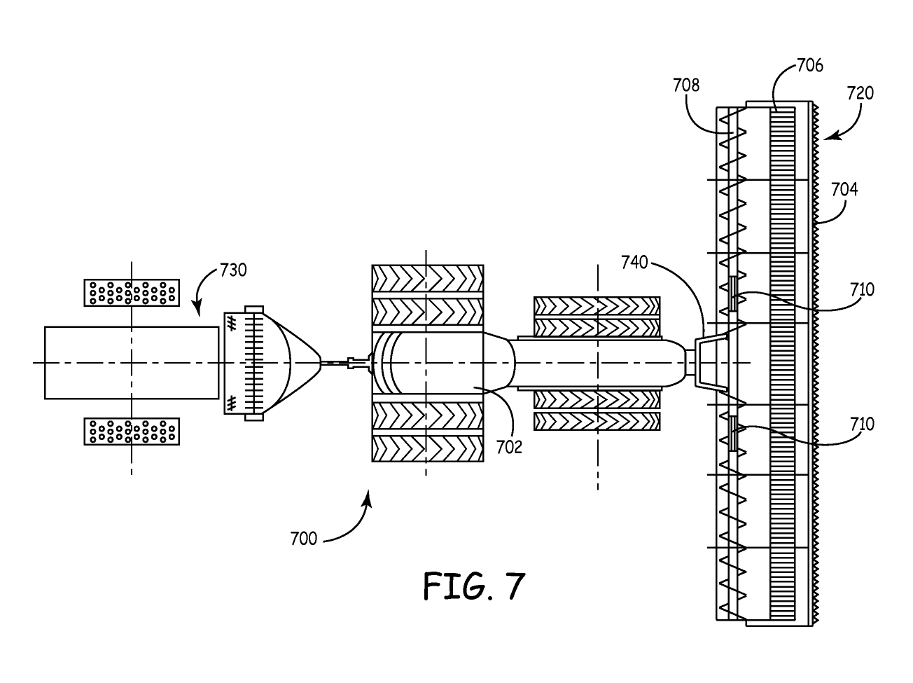

FIG. 7 is a top down view of a biomass processing system 700 that is implemented utilizing a tractor 702. System 700 optionally includes a platform 720 and a baler 730. In the particular embodiment shown in the figure, system 700 does not include a conveyor to transport the biomass from the platform 720 to the baler 730. Instead, the biomass is placed into a row on the ground and is picked-up from the ground by the baler 730. In another embodiment, system 700 does include one or more conveyors (e.g. conveyor 108 in FIG. 1 or conveyors 312, 314, 320, 322, 326, 328 in FIG. 3). Accordingly, biomass processing systems according to the present disclosure can include systems with or without conveyors. Also, it is worth pointing out that any one or more features or combination of features described in this written description or shown in the figures can be used individually or in combination with any other feature in the disclosure. For instance, any of the platforms (e.g. platform 400 in FIG. 4, platform 500 in FIG. 5, etc.) can be used alone without conveyors or balers, can be used with only a conveyor and not a baler, or can be used with only a baler and not a conveyor. Similarly, the conveyors and other components described in this disclosure can be used alone or in combination with any other devices.

Similar to some of the other embodiments of platforms, platform 700 may also include a sickle 704, pick-ups 706, and an auger 708. Platform 700 may further include grates 710 located beneath auger 708 that allows for contamination to be separated from the biomass. FIG. 7 shows that platform 700 includes two grates 710 that are placed on opposite sides of the center of the auger 708. Embodiments may however have any number of grates (e.g. 0, 1, 2, 3, etc.), and the grates may be placed at any location relative to auger 708 or at any other location in the biomass processing system.

Platform 700 is illustratively connected to tractor 702 utilizing a front end mount 740. In an embodiment, mount 740 enables a height of the platform 700, and thus the height of the sickle 704, pick-ups 706, and other components, to be adjusted. For instance, mount 740 may include a pivot or hinge that enables platform 700 to tilt up and down. Mount 740 also illustratively includes an attachment mechanism (e.g. a pin or hitch) that enables platform 700 to be attached to or separated from tractor 702.

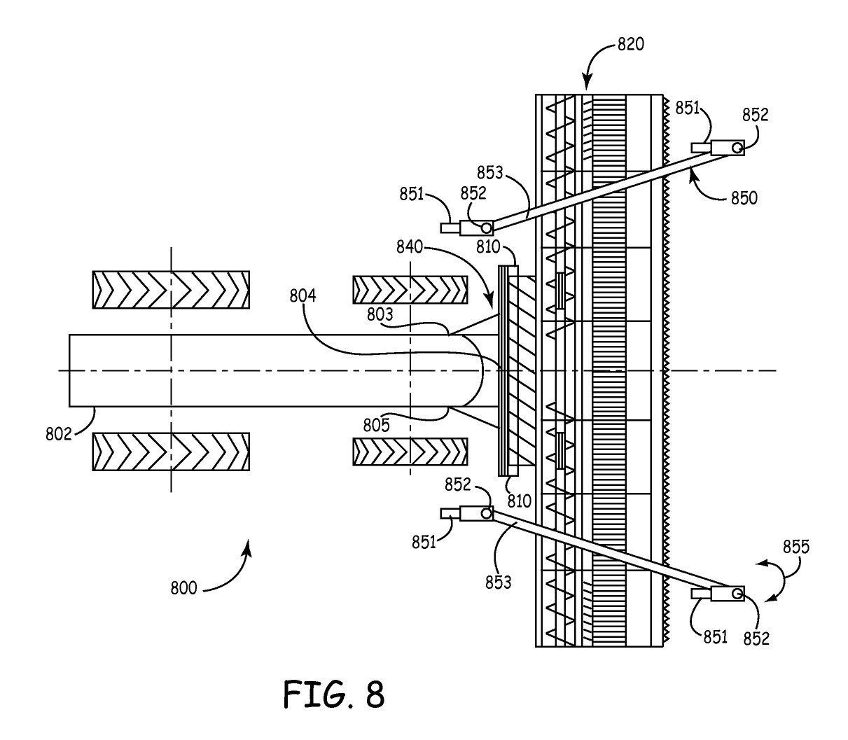

FIG. 8 is a top down view of another embodiment of a biomass processing system, system 800. In one embodiment, system 800 includes a platform 820 connected to a tractor 802 utilizing a front end mount 840. As can be seen in the figure, front end mount 840 is illustratively supported by connections to three different points 803, 804, and 805 on tractor 802. In other words, front end mount 840 may be a three-point mount system. Mount 840 may also have pivot points 810 that enable platform 820 to pivot or rotate up and down.

Biomass processing system 800 optionally includes a caster wheel (e.g. crazy wheel) assembly 850. In the particular example shown in FIG. 8, caster wheel assembly 850 includes four wheels 851. Two of the wheels 851 are placed at the front of platform 820, and the other two wheels 851 are placed at the back of platform 820. Each wheel 851 has an associated pivot shaft 852. The pivot shafts 852 allow each of the wheels 851 to rotate in a clockwise and counter-clockwise direction as shown by arrow 855. The pivot shafts 852 also allow the height of each of the wheels 851 from the ground to be independently adjusted. Each pair of wheels 851 is connected in one embodiment by a support arm 853. Support arm 853 is illustratively connected to or attached to platform 820 such that wheels 851 are able to support and control the distance of the platform 820 from the ground. It should be noted that embodiments of caster wheel assemblies 850 are not however limited to any particular configuration and include configurations other than the particular example shown in the figure. For instance, a caster wheel assembly 850 can include any number of wheels 851 (e.g. 1, 2, 3, 4, 5, etc.), and the wheels 851 can be connected to a platform 820 utilizing any attachment scheme.

In one embodiment, caster wheel assembly 850 may be useful in maintaining platform 820 at an appropriate distance from the ground. For example, a biomass field may include uneven topography features such as, but not limited to, sprinkler tracks and terraces. Without a caster wheel assembly 850, some components of platform 820 (e.g. the pick-ups) may dig into the ground when crossing a sprinkler track or terrace. However, with a caster wheel assembly 850, the platform 820 is able to maintain an appropriate height, and components (again e.g. the pick-ups) will not dig into the ground.

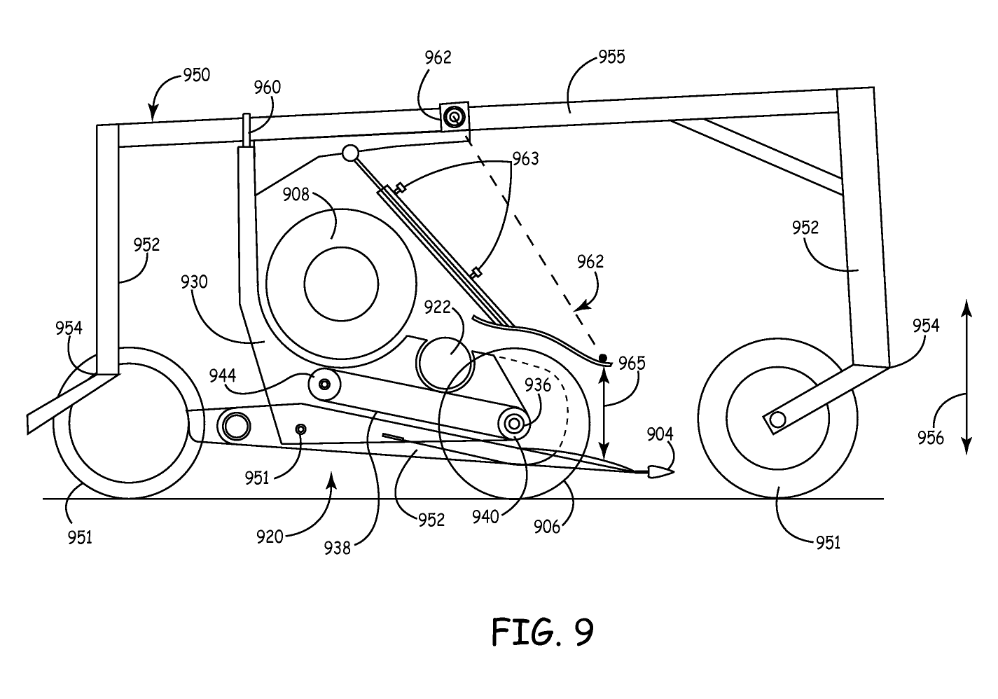

FIG. 9 is a side view of a platform 920 with an attached caster wheel assembly 950. Platform 920 includes a sickle 904, pick-ups 906, rotor 922, auger 908, and an inner support plate 930. Sickle 904 is supported by sickle support 952, and sickle support 952 is connected to inner support plate 930 at a sickle pivot point 957. Sickle pivot point 957 enables a height of sickle 904 to be adjusted relative to inner support plate 930 (i.e. the height of sickle 904 can be adjusted while the position of support plate 930 remains the same). Inner support plate 930 also has an aperture 940 that supports a rotatable axis 936 of pick-ups 906. The pick-ups 906 are rotated by a strap, belt, chain, etc. 938 that is driven by a drive mechanism 944 that may also be supported by inner support plate 930. In one embodiment, platform 920 includes one strap 938 between each tyne in pick-ups 906. Platform 920 further optionally includes a shield assembly 962. In one embodiment, the positioning of shield assembly 962 is adjusted or controlled utilizing one or more set screws 963. For instance, the distance 965 between the shield assembly 962 and pick-ups 906 is adjustable utilizing set screws 963.

Caster wheel assembly 960 is illustratively connected to platform 920 utilizing two connection points 960 and 962 on support arm 955. Connection point 960 may include an aperture that enables platform 920 to be connected with a pin. Connection point 962 may be spring loaded or could alternatively also be a pin connection. In an embodiment, points 960 and 962 enable caster wheels 951 to be able to rotate relative to platform 920. For instance, points 960 and 962 may enable caster wheels 951 to rotate clockwise and counter-clockwise in the direction shown by arrow 855 in FIG. 8. Caster wheels 951 are also illustratively able to move up and down in the vertical direction shown by arrow 956. For example, pivot shafts 952 may include a telescoping joint 954 that enables wheels 951 to extend or retract from shafts 952. In one particular embodiment, for illustration purposes only and not by limitation, point 960 includes a vertical pin, and point 960 includes two horizontal pins. The pins are spring loaded to take some of the strain out of the thrust of a counterweight when shifted into reverse. For example, a vertical pin 960 allows the front counterweight to start moving a beam holding one direction and influences the back counterweight the opposite direction, allowed by the rotation about point 960.

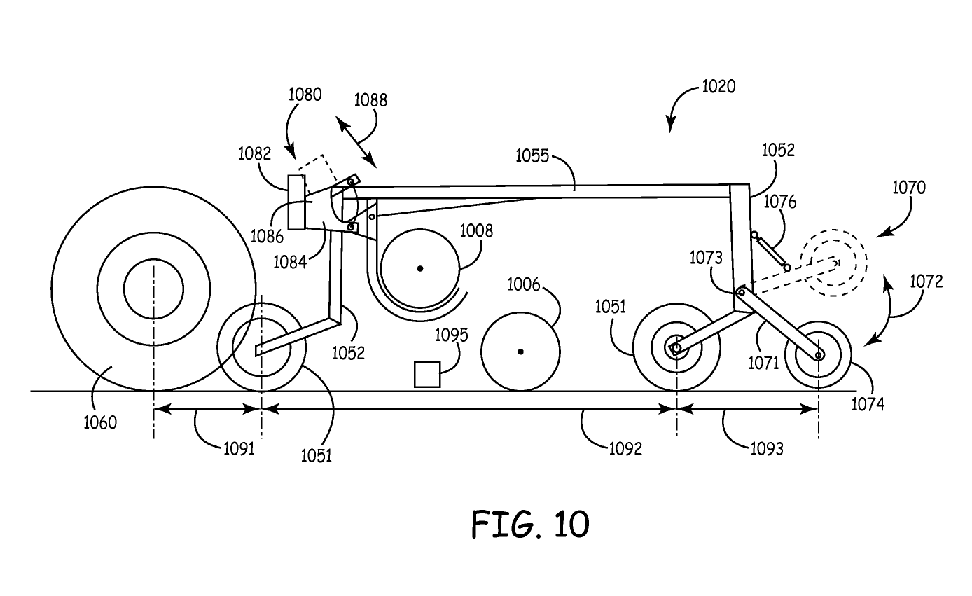

FIG. 10 is a side view of a platform 1020. Similar to the embodiment shown in FIG. 9, platform 1020 also includes pick-ups 1006, auger 1008, support arm 1055, caster wheels 1051, and pivot shafts 1052. It should be noted that several features have been removed from the view shown in FIG. 10 (e.g. pick-ups supports, inner support panels, etc.) to better illustrate other aspects of the platform.

In the embodiment shown in FIG. 10, platform 1020 optionally includes a floating wheel assembly 1070 and a hitch assembly 1080. Floating wheel assembly 1070 illustratively includes a floating wheel 1074 that is rotatably connected to a support arm 1071. Support arm 1071 is connected to platform 1020 at a pivot point 1073. Support arm 1071 may also be connected to platform 1020 by a piston 1076 that enables the floating wheel 1074 to be brought up or down in the direction shown by arrow 1072. Although FIG. 10 only shows one floating wheel assembly 1070, certain embodiments include any number of floating wheels (e.g. 0, 1, 2, 3, 4, etc.), and the floating wheels may be connected to the platform utilizing any connection mechanisms. In one embodiment, floating wheel 1074 is controlled by a control system (e.g. electrical, mechanical, pneumatic, etc.) that enables the height of the floating wheel 1074 to be automatically controlled. For example, the floating wheel 1074 can be raised automatically when a tractor is placed in reverse to allow clearance for front caster wheels 1051 to pivot when backing-up.

Platform 1020 may further optionally include a push bar 1082, a hinge 1084, and a depth control sensor 1095. Push bar 1082 is optionally mounted to a tractor or other device that carries platform 1020. Hinge 1084 rotatably connects push bar 1082 to support arm 1055 such that the platform 1020 can be titled up and down in the direction shown by arrow 1088. Optional depth control sensor 1095 is able to detect the distance to the ground. Depth control sensor 1095 is illustratively placed behind the pick-ups 1006 and is used to control the height of the platform. In one embodiment, the heights of caster wheels 1051 are hydraulically controlled based on feedback from depth control sensor 1095 such that pick-ups 1006 are slightly above the ground (e.g. pick-ups 1006 are at a height close to the ground but not touching the ground). Accordingly, the platform configuration shown in FIG. 10 can be used to automatically maintain the height of platform 1020 at an appropriate height during operation.

FIG. 10 also shows some examples of possible spacings between the front tractor wheels 1060, the caster wheels 1051, and the floating wheel 1074. In one embodiment, for illustration purposes only and not by limitation, the distance 1091 between the front tractor wheel 1060 and the back caster wheel 1051 is approximately 2 feet. The distance 1092 between the front and the back caster wheels 1051 is approximately 8-10 feet, and the distance between the front caster wheels 1051 and the floating wheel 1074 is approximately 2 feet and 6 inches. Embodiments of the present disclosure are not however limited to any particular dimensions and include any desirable dimensions.

In one embodiment, having a wheel base of 8-10 feet (e.g. distance 1092) allows a “land plane” effect of controlling the depth of the pick-ups 1006 which should be slightly above the ground. Since each caster wheel 1051 may be raised or lowered by hydraulics and the pick-ups 1006 are rigidly mounted to the platform 1020, the depth of the pick-ups 1006 can be controlled manually by an operator, automatically utilizing a sensor (e.g. sensor 1095), or semi-autonomously using both input from an operator and a sensor. Additionally, having a caster wheel distance of approximately 30 inches (e.g. distance 1093) may help to maintain the same depth of the platform 1020 while crossing various topographic features. For instance, when a caster wheel 1051 crosses a track or depression, the floating wheel 1074 enables the same height of the platform 1020 to be maintained (e.g. the platform does not sink when crossing a depression). Also for instance, the reverse effect is encountered when one of the rear caster wheels 1051 could go down a track or depression. In such a case, the front tractor wheel 1060 may hold the platform 1020 up because the hitch 1080 will hold the platform 1020 up even if the tractor wheel 1060 goes down. The platform 1020 does not need to hold the weight of the tractor because of the hitch 1080 allowing the platform to flex up to 16-18 inches.

As has been described above and shown in the accompanying figures, embodiments of the present disclosure include methods and equipment for handling and processing biomass. Biomass is illustratively harvested in a one-pass operation that includes cutting the biomass with sickles, moving the cut biomass into a row using an auger, and baling the biomass. The one-pass operation may also include transferring the biomass from the auger to the baler utilizing a conveyor, and removing contaminants from the biomass using various methods such as, but not limited to, grates, rotors, and/or cleaning modules. Accordingly, at least some embodiments of the present disclosure may be advantageous in that they increase efficiency by reducing the number of passes in harvesting biomass and may also improve the quality of biomass by reducing the amount of contaminants (e.g. dirt) in the biomass. For example, by using a conveyor between an auger and a baler, the amount of contact the biomass has with the ground is reduced by keeping the biomass elevated from the ground, and the biomass is less likely to pick-up additional contaminants. Additionally, embodiments also include other features such as caster wheels, hitches, floating wheels, and depth control sensors that can be utilized in implementing a biomass processing system. Again, it is worth noting that any one or more feature described above or shown in the figures can be used by itself or with any other combination of features described above or shown in the figures.

Finally, it is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. In addition, although the embodiments described herein are directed to biomass processing systems, it will be appreciated by those skilled in the art that the teachings of the disclosure can be applied to other types of systems, without departing from the scope and spirit of the disclosure.

1. A method for harvesting biomass comprising:
cutting the biomass;
transferring the biomass to an auger;
utilizing the auger to form a row of biomass; and
baling the row of biomass.

2. The method of claim 1, and further comprising:
transferring the row of biomass from the auger to a baler utilizing one or more conveyors.

3. The method of claim 2, wherein the row of biomass is elevated from the ground while it is being transferred from the auger to the baler.

4. The method of claim 1, and further comprising:
performing one or more cleaning steps to separate contaminants from the biomass.

5. (canceled)

6. The method of claim 4, wherein performing the one or more cleaning steps comprises:
projecting a fluid at the biomass.

7. The method of claim 4, wherein performing the one or more cleaning steps comprises:
providing an opening that enables the contaminants to fall to the ground.

8. A biomass processing system comprising:
a sickle that is configured to cut biomass;
a pick-ups unit that is configured to transfer the cut biomass; and
an auger that is configured to receive the cut biomass from the pick-ups unit and to form the cut biomass into a row.

9. The system of claim 8, wherein a height of the sickle relative to the pick-ups unit is adjustable.

10. (canceled)

11. The system of claim 8, and further comprising:
one or more grates configured to reduce contamination included within the cut biomass.

12. The system of claim 8, and further comprising:
a conveyor that is configured to receive the row of cut biomass from the auger.

13. The system of claim 12, and further comprising:
a baler that is configured to receive the row of cut biomass from the conveyor.

14. The system of claim 13, wherein the biomass is elevated from the ground between the pick-ups unit and the baler.

15. A biomass processing platform comprising:
an auger;
a pick-ups unit that transfers biomass to the auger; and
a sickle that has an adjustable height relative to the pick-ups unit and the auger.

16. The platform of claim 15, and further comprising:
one or more castor wheels.

17. The platform of claim 16, and further comprising:
one or more floating wheels.

18. The platform of claim 15, and further comprising:
a hitch having a pivotable hinge.

19. The platform of claim 15, and further comprising:
a depth control sensor that is utilized in adjusting the height.

20. (canceled)
